(19) United States
(12) Patent Application Publication
(10) Pub. No.: US 2007/0144354 A1
(43) Pub. Date: Jun. 28, 2007

(54) AUTOMATED MONITORING OF THE CONDITION OF AN AIR FILTER IN AN ELECTRONICS SYSTEM

(76) Inventors: P. Keith Muller, San Diego, CA (US); David G. Wang, San Diego, CA (US)

Correspondence Address: John D. Cowart;Intellectual Property Section, Law Department, NCR Corporation, 1700 South Patterson Blvd., Dayton, OH, 45479-0001, US

(21) Appl. No.: 11/460,639

(22) Filed: Jul. 28, 2006

Related U.S. Application Data
(60) Provisional application No. 60/753,166, filed on Dec. 22, 2005.

(51) Int. Cl. B01D 50/00

(52) U.S. Cl. 96/417

(57) ABSTRACT

A technique for use in monitoring the condition of an air filter in an electronics system involves receiving temperature readings gathered over time by a temperature sensor located in the electronics system that houses the air filter, concluding that at least one of the readings exceeds a reference temperature, concluding that a rate of change of at least some of the readings does not exceed a reference rate, and generating an alarm message indicating that the air filter needs attention.

### CROSS-REFERENCE TO RELATED APPLICATION

This application claims benefit of U.S. Provisional Application 60/753,166, filed on Dec. 22, 2005.

### BACKGROUND

Controlling airborne-contaminant levels in rooms that house computers and other electronics equipment is critical for the proper operation and the longevity of the equipment. Unfortunately, while the impact of airborne contamination on electronics equipment is understood in general, many owners of electronics equipment overlook the most harmful of contaminants because of their small size. In addition to dust and other large-particle contaminants, the operation of electronics equipment is typically hindered by small particles and gasses as well. Effects typically range from intermittent interference with operation of the equipment to actual, and often devastating, component failures.

Despite their considerable investments in computer and other electronics equipment, many owners of such equipment fail to realize that they must maintain a clean environment for the equipment and that failure to do so diminishes the value of their investment. Failure on the part of equipment owners to maintain a clean environment for the equipment also has adverse impact on the vendors of that equipment, forcing the vendors to expend resources in designing to avoid such failures or in servicing or replacing equipment that has failed prematurely as a result of a contaminated environment. These types of equipment failure not only cause direct financial harm to the owners and vendors of the equipment, they also damage the vendors' reputations as producers of quality products.

One common solution that equipment vendors use in battling this problem of environmental contamination is the incorporation of air filters into electronics systems. Unfortunately, however, air filters increase airflow impedance within the system, thus requiring more fan power to move cool air through the system than is required when no air filter is present. This impedance to air flow becomes even more pronounced as the air filter becomes clogged over time by contaminants filtered from the air entering the system. In general, the longer an air filter is in service, the higher its flow impedance. Also, the more contaminated the environment in which the air filter operates, the shorter the life of the filter, as shown in the chart of FIG. 1. In this figure, the curve representing the “heavy contamination” environment hits the point for an expected “filter change” sooner than the curve for the “light contamination” environment hits that point.

Because the amount of airflow that any particular fan can produce is limited by the capabilities of the fan, clogged air filters in electronic systems often impede airflow so significantly that the total flow rates into the systems become less than are required for proper cooling of the systems. The chart of FIG. 2 shows that, as the air flow impedance (“impedance curve”) of an air filter rises, the air flow rate (“flow rate” curve) through the filter falls. As shown by the chart of FIG. 3, this drop in air flow rate (“flow rate” curve) in an electronics system brings on a resulting increase in temperature (“component temperature” curve) within the system. The result is that, once the fan(s) in the system has reached maximum air flow potential, the system will begin to overheat, which of course, if left unchecked, could lead to a degradation of performance or even system failure.

To ensure that system failure does not occur as a result of filter clogging, equipment owners and vendors typically inspect and replace air filters on a regular basis. Inspection of filters, however, requires human presence at the equipment site, which drives up the cost of ownership of the equipment. Also, because inspections typically take place on fixed schedules and environmental conditions typically vary from site to site, the replacement of air filters often does not occur in a timely manner. Visits to cleaner environments, for example, are often unnecessary or premature, as the air filters in these environments do not clog as quickly. Similarly, visits to more heavily contaminated sites often result in delinquent filter changes, which in turn often lead to irreversible damage or premature aging of system components as a result of persistent overheating.

### SUMMARY

Described below are a system and technique for use in monitoring the condition of an air filter in an electronics system. The technique involves receiving temperature readings gathered over time by a temperature sensor located in the electronics system that houses the air filter, concluding that at least one of the readings exceeds a reference temperature, concluding that a rate of change of at least some of the readings does not exceed a reference rate, and generating an alarm message indicating that the air filter needs attention.

In some cases, temperature readings are received from multiple temperature sensors, and the technique involves concluding that at least one reading from another of the temperature sensors exceeds a corresponding reference temperature. The technique also often involves concluding that a rate of change in readings from each of at least two of the sensors does not exceed a corresponding reference rate. In some cases, the technique involves concluding that consecutive readings from a single one of the temperature sensors have exceeded the reference temperature.

Some versions of the technique involve concluding that an air-moving device in the electronics system is operating at no less than a reference speed before generating the alarm message. Other versions involve concluding that the air-moving device is operating below a reference speed and, before generating the alarm message, instructing the air-moving device to increase its speed. In still other versions, the technique involves concluding that an air-moving device has increased its operating speed at least once after a first temperature reading that exceeded the reference temperature was received.

Other features and advantages will become apparent from the description and claims that follow.

### BRIEF DESCRIPTION OF THE DRAWINGS

FIGS. 1, 2 and 3 are charts showing the relationships between airborne contamination levels, air flow rates, and temperatures in the environments surrounding computer and other electronics equipment.

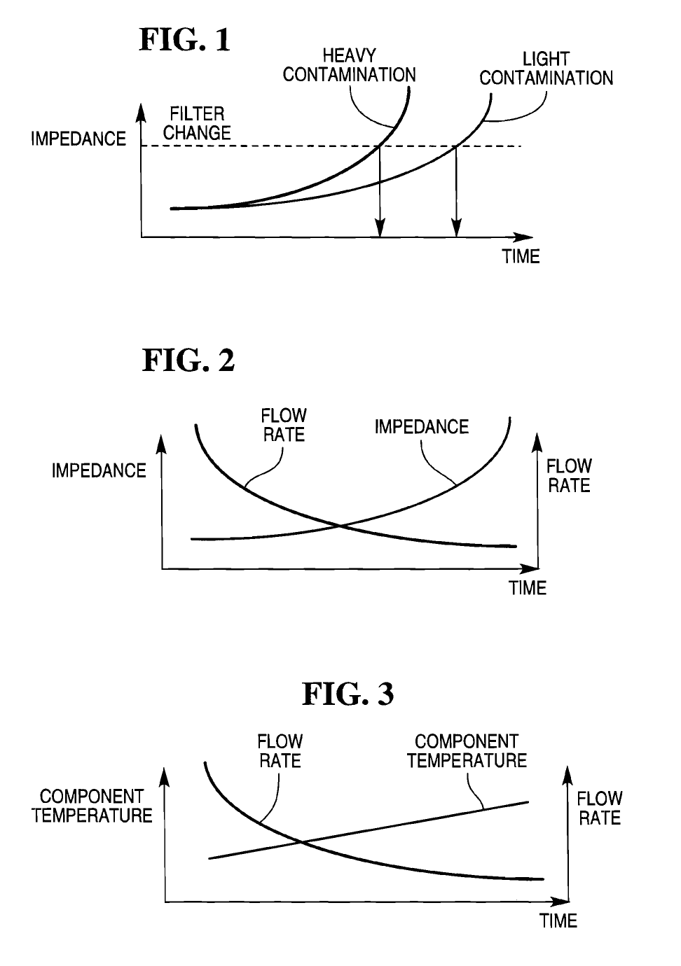

FIG. 4 is a diagram showing an electronics system equipped for automated monitoring the condition of an air filter in the system.

FIG. 5 is a chart showing the relationships among air flow impedance, flow rate, and component temperatures in an electronics system.

FIG. 6 is a diagram showing the structure of a computer system suitable for use as a controller in the system of FIG. 4

FIG. 7 is a diagram showing the flow of a process for use in monitoring the condition of an air filter in an electronics system.

FIG. 8 is a chart showing the relationships among air flow impedance, flow rate, and component temperatures in an electronics system having a variable-speed fan.

FIG. 9 is a diagram showing the flow of a process for use in monitoring the condition of an air filter in an electronics system having a variable-speed fan.

### DETAILED DESCRIPTION

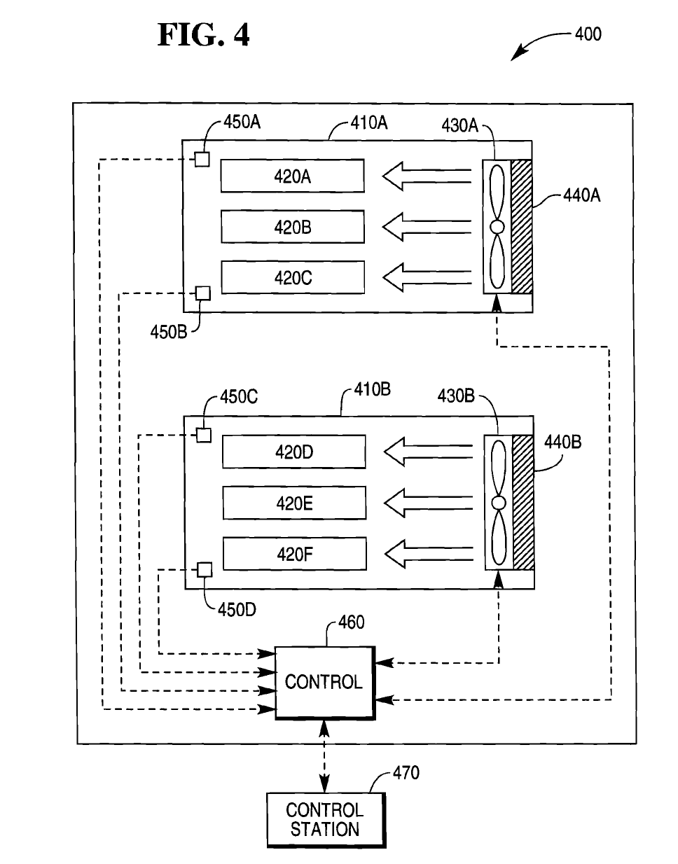

FIG. 4 shows an electronics system 400 that is equipped for automated monitoring of air-filter condition in the system. The system 400 typically includes one or more electronic assemblies 410A-B, such as computing nodes or disk-drive arrays, which each in turn includes one or more electronic sub-assemblies or components 420A-F that generate heat and require cooling. In most systems, cooling of the electronic components 420A-F within the electronic assemblies 410A-B is accomplished, at least in part, by one or more fans 430A-B or other air-moving devices (e.g., blowers) that draw cool air into the assemblies and force the cool air over the electronic components 430A-F. Each of the electronic assemblies also includes one or more air filters 440A-B that filter contaminants from the air entering the assembly. In some systems, each assembly has multiple filters of varying granularity, with some removing the smallest contaminant particles and others removing larger particles. Alternatively, in some systems, a single fan or array of fans or a single filter or group of filters are positioned to serve multiple electronic assemblies at once.

The electronics system 400 also includes one or more temperature sensors 450A-D that are positioned as needed throughout the system to measure temperatures within the system. In the example shown here, each of the electronic assemblies 410A-B includes two of the temperature sensors 450A-D positioned in close proximity to the electronic components 420A-F that generate heat. The temperature sensors 450A-D are useful not only in measuring the temperatures at various points within the system at any given time, but also in monitoring the rates at which temperature changes occur at those points in the system. This information about rates of change in temperature, in turn, is useful in monitoring the degrees to which the air filters 440A-B in the system are clogged with airborne contaminants.

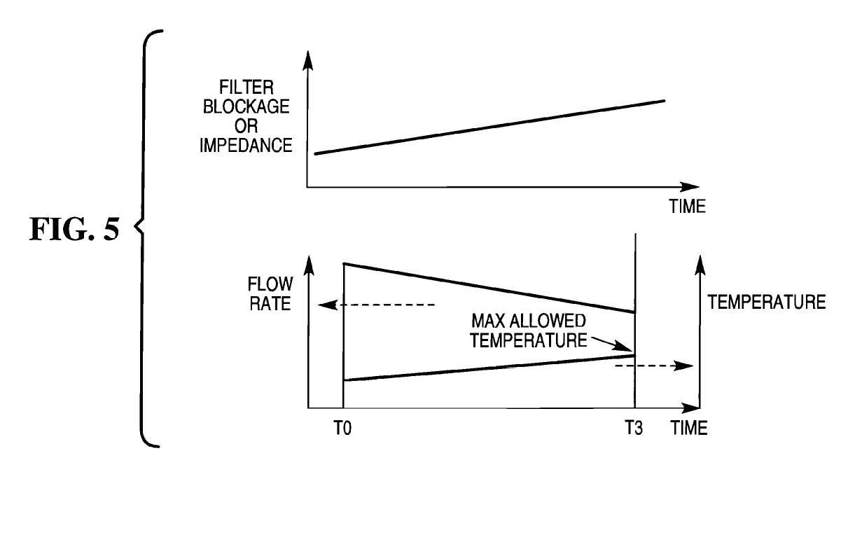

FIG. 5 includes two charts showing that, as the amount of clogging, or air flow impedance, in an air filter rises, the air flow rate out of the corresponding fan declines, and the temperatures of the temperature sensors as well as other electronic components cooled by the fan in turn rise. This rise in component temperatures, however, is very gradual over time, occurring only very slightly as the filter becomes increasingly clogged. The temperature rises are so gradual, in fact, that they are typically detectable only by monitoring temperatures within the system over a long period of time, typically several weeks or months. At some point, however, the rise in temperatures that is attributable to clogged air filters becomes so great that the component temperatures exceed acceptable maximum values, and the risk of overheating becomes imminent. By watching for this condition to occur, the system can alert a human administrator to the possibility that a filter change is in order.

The electronics system 400 of FIG. 4 includes a control system 460 that records the temperatures measured at the temperature sensors 450A-D over time and watches for a gradual rise in temperature at one or more of the sensors that eventually reaches the maximum value. As described in more detail below, a temperature reading at one of the temperature sensors 450A-D in excess of the predetermined maximum value initiates a process which, in some cases, leads to the generation of an alarm signal that is delivered to a human user at a control station 470 to indicate that a change of the air filter 440A-B is probably needed. In some systems, such as those that include variable-speed fans, the control system 460 receives information from each of the fans 430A-B indicating the fan's current speed and, when necessary, instructs the fan to increase its speed (also described below).

The control station 470 is typically used to monitor and control a large number of electronics systems, such as the dozens or even hundreds of computing systems that are often found in large data centers. In many cases, the control station 470 is a remote administration station, housed at a physical location that is geographically distant from the electronics systems it monitors (e.g., in a different physical building or even a different city or country). In some cases, the control station 470 acts in addition to or instead of the control system 460 to monitor the temperatures within the various electronics assemblies 410A-B in the electronics system 400.

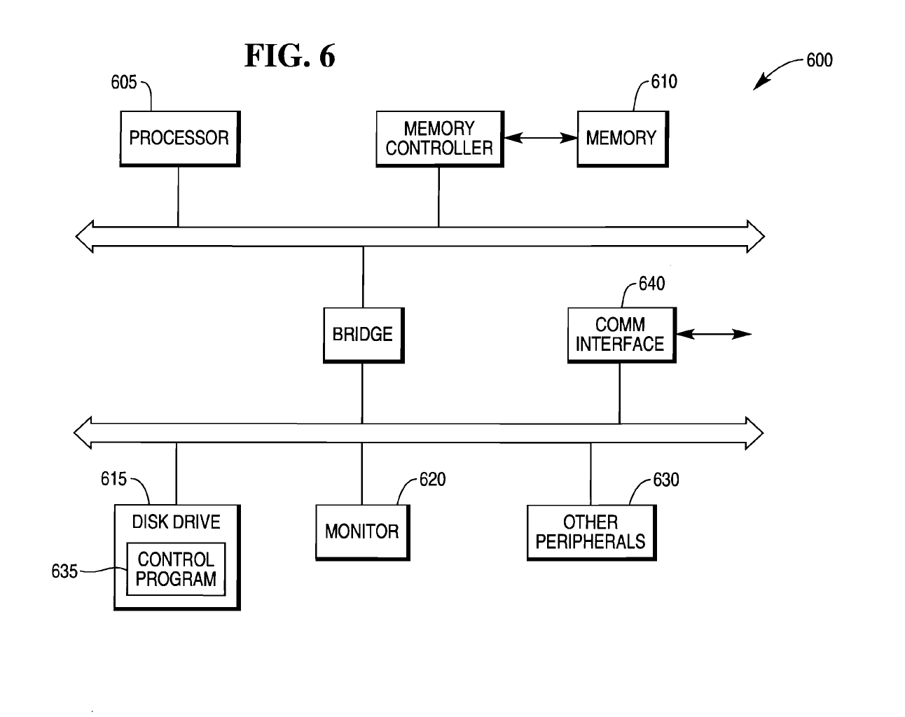

FIG. 6 shows a computer system 600 suited for use in one or both of the control system and control station of FIG. 4. In general, the computer system 600 includes one or more processors 605, one or more temporary data-storage components 610 (e.g., volatile and nonvolatile memory modules), one or more persistent data-storage components 615 (e.g., optical and magnetic storage devices, such as hard and floppy disk drives, CD-ROM drives, and magnetic tape drives), one or more input devices 620 (e.g., mice, keyboards, and touch-screens), and one or more output devices 630 (e.g., display consoles and printers).

The computer system 600 includes executable program code in the form of a control program 635 that is usually stored in one of the persistent storage media 615 and then copied into memory 610 at run-time. The processor 605 executes the code by retrieving program instructions from memory in a prescribed order. When executing the program code, the computer receives data from the input and/or storage devices, performs operations on the data, and then delivers the resulting data to the output and/or storage devices.

In some systems, the computer is a special-purpose computer that performs only certain, specialized functions. In other systems, the computer is a general-purpose computer programmed to perform the functions needed by the owner of the system.

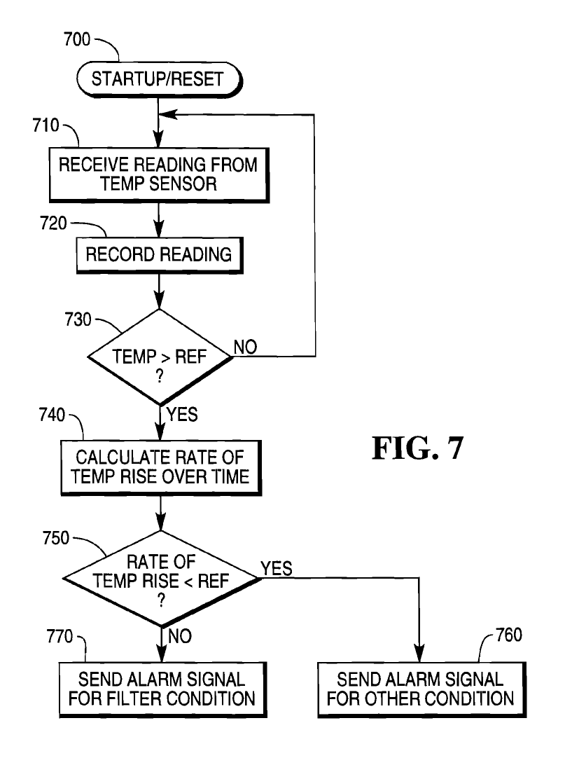

FIG. 7 is a diagram showing a process flow for use in a control system like that of FIG. 4 in monitoring temperatures in an electronics system and, when necessary, in generating an alarm signal to indicate that an air filter is in need of replacement. On startup or on reset of the control system (step 700), the system begins a process in which it receives a temperature reading from one or more temperature sensors from time to time (step 710) and records each of the readings (720), typically by storing the readings in one or more storage media like those shown in FIG. 6.

On receiving each temperature reading, the control system compares the temperature value to a reference value, which equals a predetermined value for that sensor which is associated with the acceptable maximum values for the electronics system, electronic assemblies, or electronic components being monitored (step 730). If the temperature value does not exceed the reference value, the control system takes no action and waits for the next temperature reading, or set of readings, to arrive.

If, on the other hand, one of the temperature readings does exceed the reference value, the control system then assesses whether the increase in temperature occurred gradually over time or more suddenly. In most cases, rapid changes in temperature indicate a problem or condition other than a clogged air filter. In making this assessment, the control system first calculates the average rate of temperature change at the sensor over some selected period of time (step 740) and compares this rate of change to a reference value (step 750). If the average rate of temperature change at the sensor exceeds the reference value, then the control system concludes that a problem or condition other than a clogged filter exists. In response, the control system either does nothing or sends an alarm signal to the control station to indicate that something has caused a rapid temperature rise (760). If the average rate of temperature change at the sensor does not exceed the reference value, however, the control system concludes that the temperature change is the result of a clogged air filter and sends the corresponding alarm signal to the control station (step 770).

In many systems, relying on a single temperature reading that exceeds the reference value to generate an alarm signal would lead to frequent false alarms. As a result, many systems require redundant high readings before sending an alarm signal. One technique involves sending the alarm signal only after a single temperature sensor has delivered high temperature values for some number of consecutive readings representing the passage of some minimum amount of time. Another technique involves sending the alarm signal only if multiple temperature sensors have delivered high readings over some period of time. In some of these systems, the control system verifies that the average rate of change in temperature at two or more of the sensors does not exceed a corresponding reference rate before generating the alarm signal. Given the very gradual nature of temperature changes associated with the clogging of air filters, redundant techniques such as these are useful in ensuring that any alarm signal generated gives an accurate indication that a filter change is needed.

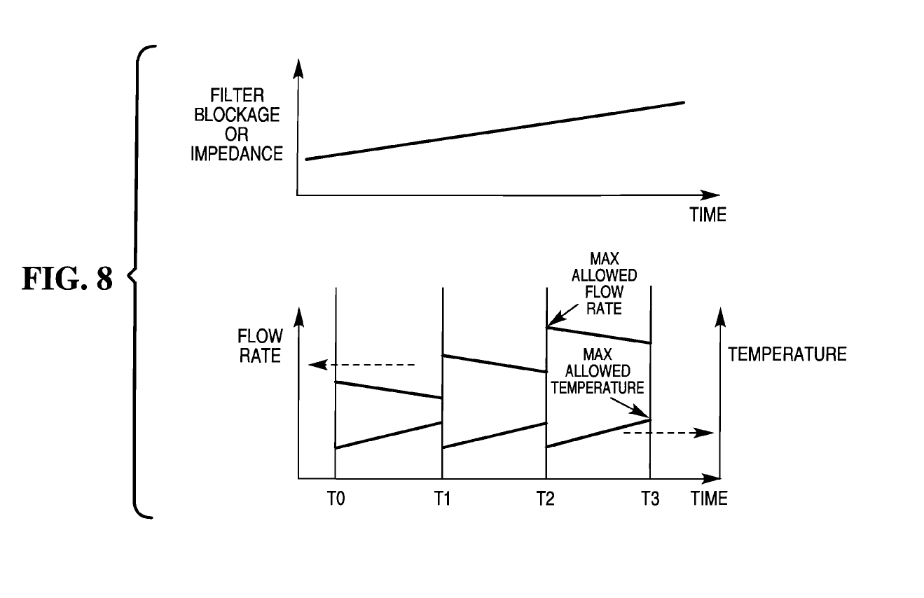

FIG. 8 includes two charts showing the relationships among air flow impedance, air flow rate, and temperature for an electronics system having a variable-speed fan. At startup (time T0), the temperature in the system is relatively low, and the fan operates at less than its maximum speed. Over time, as airborne contaminants clog the air filter in the system, airflow impedance increases and the air flow rate in the system decreases, increasing temperature.

When the temperature reaches the acceptable maximum value (time T1), the fan increases its speed by some amount, which in turn leads to an immediate jump in air flow rate and an near-immediate drop in temperature. As the air filter continues to remove contaminants from the incoming air, the air flow rate again declines, and the temperature again begins to rise. Eventually the temperature will reach the acceptable maximum value again (time T2), and the fan will increase its speed once again by some amount.

At some point after the fan reaches its maximum speed, the temperature again reaches the acceptable maximum amount (time T3). When this occurs, the fan is no longer able to offset the clogging of the filter, and the system generates the alarm signal to indicate that a filter change is needed.

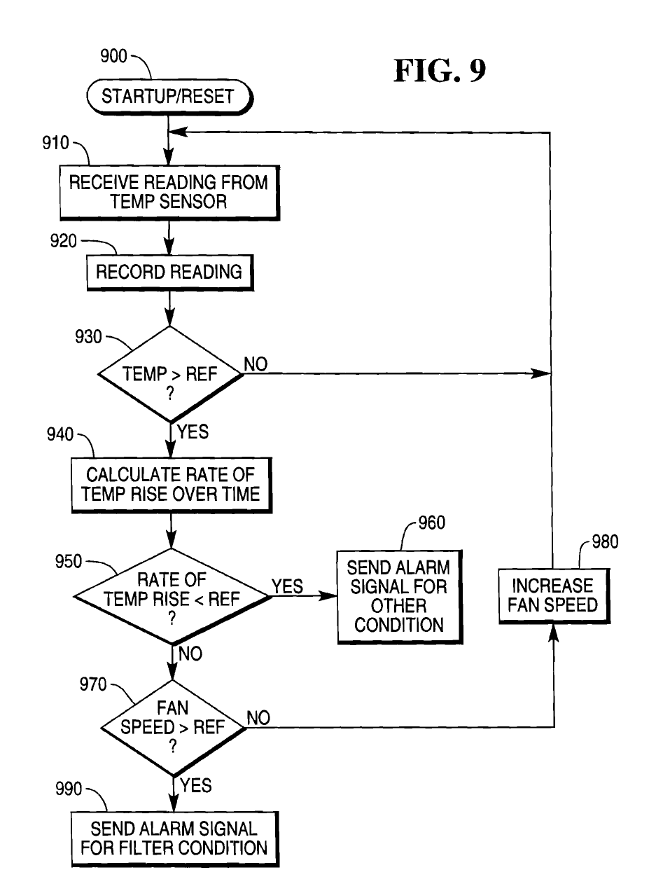

FIG. 9 shows a process flow for a system with a variable-speed fan like that of FIG. 8. On startup or on reset of the control system (step 900), the system begins a process in which it receives a temperature reading from one or more temperature sensors from time to time (step 910) and records each of the readings (920), typically by storing the readings in one or more storage media.

On receiving each temperature reading, the control system compares the temperature value to a reference value, which equals the predetermined maximum value for that particular sensor (step 930). If the temperature value does not exceed the reference value, the control system takes no action and waits for the next temperature reading, or set of readings, to arrive.

If, on the other hand, one of the temperature readings does exceed the reference value, the control system then assesses whether the increase in temperature occurred gradually over time or more suddenly. To do so, the control system first calculates the average rate of temperature change at the sensor over some selected period of time (step 940) and compares this rate of change to a reference value (step 950). If the average rate of temperature change at the sensor exceeds the reference value, then the control system concludes that a problem or condition other than a clogged filter exists. In response, the control system either does nothing or sends an alarm signal to the control station to indicate that something has caused a rapid temperature rise (960).

If the average rate of temperature change at the sensor does not exceed the reference value, the control system concludes that the temperature change is the result of a clogged air filter. Before generating an alarm signal, however, the control system assesses whether the corresponding variable-speed fan (or set of fans) is operating at its maximum speed or above some reference value (step 970). If not, the control system instructs the fan to increase its speed (step 980) and continues with the monitoring process. If, on the other hand, the fan is already operating at its maximum speed or above the reference value, the control system delivers the alarm signal to the control station (step 990).

The text above describes one or more specific embodiments of a broader invention. The invention also is carried out in a variety of alternative embodiments and thus is not limited to those described here. Many other embodiments are also within the scope of the following claims.

We claim:

1. A control system for use in monitoring the condition of an air filter in an electronics system, the control system comprising a computer processor configured to:
receive temperature readings gathered over time by a temperature sensor located in the electronics system that houses the air filter;
conclude that at least one of the readings exceeds a reference temperature;
conclude that a rate of change of at least some of the readings does not exceed a reference rate; and
generate an alarm message indicating that the air filter needs attention.

2. The system of claim 1, where, in receiving temperature readings, the processor is configured to receive temperature readings from multiple temperature sensors.

3. The system of claim 2, where, after concluding that at least one of the readings exceeds a reference temperature, the processor is configured to conclude that at least one reading from another of the temperature sensors exceeds a corresponding reference temperature.

4. The system of claim 2, where, after concluding that at least one of the readings exceeds a reference temperature, the processor is configured to conclude that a rate of change in readings from each of at least two of the sensors does not exceed a corresponding reference rate.

5. The system of claim 1, where, after concluding that at least one of the readings exceeds a reference temperature, the processor is configured to conclude that consecutive readings from a single one of the temperature sensors have exceeded the reference temperature.

6. The system of claim 1, where the processor is configured to conclude that an air-moving device in the electronics system is operating at no less than a reference speed before generating the alarm message.

7. The system of claim 1, where the processor is configured to conclude that an air-moving device in the electronics system is operating below a reference speed and, before generating the alarm message, instructing the air-moving device to increase its speed.

8. The system of claim 1, where, before generating the alarm signal, the processor is configured to conclude that an air-moving device has increased its operating speed at least once after the processor first received a temperature reading that exceeded the reference temperature.

9. A computer program for use in monitoring the condition of an air filter in an electronics system, the program comprising executable instructions that, when executed by a computer system, cause the system to:
receive temperature readings gathered over time by a temperature sensor located in the electronics system that houses the air filter;
conclude that at least one of the readings exceeds a reference temperature;
conclude that a rate of change of at least some of the readings does not exceed a reference rate; and
generate an alarm message indicating that the air filter needs attention.

10. The program of claim 9, where, in receiving temperature readings, the system is configured to receive temperature readings from multiple temperature sensors.

11. The program of claim 10, where, after concluding that at least one of the readings exceeds a reference temperature, the system is configured to conclude that at least one reading from another of the temperature sensors exceeds a corresponding reference temperature.

12. The program of claim 10, where, after concluding that at least one of the readings exceeds a reference temperature, the system is configured to conclude that a rate of change in readings from each of at least two of the sensors does not exceed a corresponding reference rate.

13. The program of claim 9, where, after concluding that at least one of the readings exceeds a reference temperature, the system is configured to conclude that consecutive readings from a single one of the temperature sensors have exceeded the reference temperature.

14. The program of claim 9, where the system is configured to conclude that an air-moving device in the electronics system is operating at no less than a reference speed before generating the alarm message.

15. The program of claim 9, where the system is configured to conclude that an air-moving device in the electronics system is operating below a reference speed and, before generating the alarm message, instructing the air-moving device to increase its speed.

16. The program of claim 9, where, before generating the alarm signal, the system is configured to conclude that an air-moving device has increased its operating speed at least once after the processor first received a temperature reading that exceeded the reference temperature.

17. A method for use in monitoring the condition of an air filter in an electronics system, the method comprising:
receiving temperature readings gathered over time by a temperature sensor located in the electronics system that houses the air filter;
concluding that at least one of the readings exceeds a reference temperature;
concluding that a rate of change of at least some of the readings does not exceed a reference rate; and
generating an alarm message indicating that the air filter needs attention.

18. The method of claim 17, where receiving temperature readings includes receiving temperature readings from multiple temperature sensors.

19. The method of claim 18, further comprising concluding that at least one reading from another of the temperature sensors exceeds a corresponding reference temperature.

20. The method of claim 18, further comprising concluding that a rate of change in readings from each of at least two of the sensors does not exceed a corresponding reference rate.

21. The method of claim 17, further comprising concluding that consecutive readings from a single one of the temperature sensors have exceeded the reference temperature.

22. The method of claim 17, further comprising concluding that an air-moving device in the electronics system is operating at no less than a reference speed before generating the alarm message.

23. The method of claim 17, further comprising concluding that an air-moving device in the electronics system is operating below a reference speed and, before generating the alarm message, instructing the air-moving device to increase its speed.

24. The method of claim 17, further comprising concluding that an air-moving device has increased its operating speed at least once after a first temperature reading that exceeded the reference temperature was received.
